(19) United States
(12) Patent Application Publication
(10) Pub. No.: US 2002/0188764 A1
(43) Pub. Date: Dec. 12, 2002

(54) Method and apparatus for asynchronous component invocation

(75) Inventors: Masood Mortazavi, Cupertino, CA (US); Vladimir Matena, Redwood City, CA (US); Sanjeev Krishnan, Cupertino, CA (US); Rahul Sharma, San Jose, CA (US)

Correspondence Address: BEYER WEAVER & THOMAS LLP, P.O. BOX 778, BERKELEY, CA, 94704-0778, US

(73) Assignee: Sun Microsystems, Inc.

(21) Appl. No.: 09/865,978

(22) Filed: May 25, 2001

(51) Int. Cl. G06F 9/44; G06F 9/46

(52) U.S. Cl. 709/315; 709/330

(57) ABSTRACT

Methods and apparatus for a first component to asynchronously invoke a second component are provided. In one embodiment of the invention, a computer-implemented method for a first component to invoke a second component asynchronously in an object-oriented computing environment is provided. A request is received from a first component to invoke a second component. The scope of the received request is maintained. A thread is provided for identifying the received request and invoking the second component, wherein the thread identifies an exception listener for handling exceptions associated with the invocation of the second component.

### BACKGROUND OF THE INVENTION

1. Field of Invention

The present invention relates generally to component or object invocation. More particularly, the present invention relates to asynchronously invoking components that are not accessible by direct reference. Still more specifically, the present invention provides an exception handler allowing asynchronous invocation of remote objects.

2. Description of the Related Art

The Java 2 Platform, Enterprise Edition (J2EE) is an industry-standard general purpose platform for the development of enterprise business applications. The enterprise business applications developed for J2EE include transaction processing applications, such as telephony processing, for handling transactions on Internet servers. The application logic of these applications is typically implemented as components, particularly as Enterprise JavaBeans (EJB) components. EJB is the application component model of the J2EE platform. One of the key advantages of the EJB component model is that it is relatively easy for application developers to design and implement EJB applications. In addition, as the EJB is a popular industry standard, there are a number of already existing powerful application development tools that further simplify the development of EJB applications.

In general, an EJB component model is a component architecture for the development and the deployment of object-oriented, distributed, enterprise-level applications. An application developed using the EJB component model is scalable and transactional, and is typically portable across multiple platforms, which enables an EJB component to effectively be “written once” and “used substantially anywhere.” That is, EJB components may also be used by multiple applications, i.e., EJB components may be shared or reused. As will be understood by those skilled in the art, the EJB component model enables application development to be simplified due, at least in part, to the fact that typically difficult programming problems are implemented by an EJB container, and not the application.

As will be appreciated by one of skill in the art, EJB components often invoke other EJB components to perform particular functions. An EJB component can be directly accessible to another EJB component, or the EJB component may only be accessible the other EJC component through an asynchronous proxy or a stub. One example of a situation where and EJB component can only access another EJB component through a stub is when the EJB components reside on separate network nodes or separate servers. An EJB component running on server A can invoke EJB component running on server B by performing a remote invocation specifying that EJB component on server A wait for a response from the remote EJB component. In other words, the EJB component invocation is performed synchronously. The invocation of a remote EJB component typically includes a return type and application specific exceptions.

In many enterprise-level applications, however, it is unacceptable for a server A to even momentarily delay processing to wait for a response from server B. The server could be handling other transactions or messages instead of waiting for a response. To prevent waiting, some systems allow a server to poll for a response while server A continues processing. Other systems call for the creation of a new thread to invoke a remote EJB component. A thread scheduler would allow server A to continue processing while one particular thread waits for a response. Both threads and polling, however, introduce added complexity and computing overhead to a system. Furthermore, even with separate threads or polling, the object invocations remain synchronous. That is, a server A still waits for response from server B. Many telecommunications applications explicitly require asynchronous object invocations.

Common Object Request Broker (CORBA) provides a framework for asynchronous messaging. CORBA is described in “Common Object Request Broker: Architecture and Specification: CORBA 2.4.1”, November 2000, the entirety of which is hereby incorporated by reference for all purposes. CORBA requires derived types, however, that introduce unnecessary complexity into the programming model. CORBA provides a set of interfaces that is independent of where the object is located or what language the object is implemented in. However, support for asynchronous object invocations in CORBA is a complex patchwork solution placed on top of the synchronous object invocation framework. For example, a synchronous interface in CORBA may be represented as follows:

interface A {
int foo(float) throws exception1, exception2, exception3;
}

A call to foo with a float argument returns an integer and may throw application specific exceptions. To allow asynchrony, CORBA redefines the interface with derived types as follows:

```
interface A {
  void foo(float foo_callback c);
}
interface foo_callback {
  void handlereturnforfoo(int);
  void handleexception1(exception1);
  void handleexception2(exception2);
  void handleexception3(exception3);
}
```

A simple one method interface becomes a more complex five method interface. One method must handle the return for foo and separate methods are written for each exception. It should be noted that the number of methods in the interface grows with the number of application specific exceptions. The use of derived types in CORBA unnecessarily increases complexity of the programming model.

Currently available techniques for synchronous and asynchronous object invocation have significant disadvantages particularly with respect to computational overhead and programming model complexity. It is therefore desirable to provide an effective way to improve upon asynchronous object invocation that exhibits desirable characteristics as well or better than the technologies discussed above.

### SUMMARY OF THE INVENTION

The present invention relates to asynchronous component invocation. In one aspect of the invention, a computer-implemented method for a first component to invoke a second component asynchronously in an object-oriented computing environment is provided. A request is received from a first component to invoke a second component. The scope of the received request is maintained. A thread is provided for identifying the received request and invoking the second component, wherein the thread identifies an exception listener for handling exceptions associated with the invocation of the second component.

According to one embodiment, a queue is used to hold requests from the first component. A worker thread can be used to dequeue the received request after receiving a transaction commit signal from a container associated with the first and second components.

In another aspect of the invention, a computer-implemented method for a first component to invoke a second component asynchronously in an object-oriented environment. A second component for handling a message is identified. A request associated with the message is transmitted from a first component to invoke the second component. An exception listener is registered on an asynchronous proxy associated with the second component.

In another aspect of the invention an enterprise environment associated with a computing system is provided. The enterprise environment includes an asynchronous proxy for receiving a request from a first component to invoke a second component and an exception listener coupled to the asynchronous proxy, wherein the exception listener uses a scope corresponding to the request to handle exceptions associated with the invocation.

In another aspect, an enterprise environment associated with a computing system is provided. The computing system includes memory containing a first component, a processor coupled with memory. The processor is configured to identify a second component for handling a message from the first component. The computing system also includes an interface coupled with the processor and memory. The interface is configured to transmit a request associated with the message from the first component to invoke the second component, wherein the interface also transmits information to register an exception listener on an asynchronous proxy associated with the second component.

Another aspect of the invention pertains to computer program products including a machine readable medium on which is stored program instructions, tables or lists, and/or data structures for implementing a method as described above. Any of the methods, tables, or data structures of this invention may be represented as program instructions that can be provided on such computer readable media.

A further understanding of the nature and advantages of the present invention may be realized by reference to the remaining portions of the specification and the drawings.

### BRIEF DESCRIPTION OF THE DRAWINGS

The invention may best be understood by reference to the following description taken in conjunction with the accompanying drawings in which:

FIG. 1 is a diagrammatic representation of a system that can use the techniques of the present invention, according to specific embodiments.

FIG. 2 is a diagrammatic representation of asynchronous component invocation, according to specific embodiments.

FIG. 3 is a process flow diagram that illustrates the receipt of a message and the asynchronous invocation of a remote component, according to specific embodiments.

FIG. 4 is a process flow diagram that illustrates asynchronous invocation and exception handling, according to specific embodiments.

FIG. 5 is a diagrammatic representation of a general-purpose computer system that is suitable for implementing the present invention.

### DETAILED DESCRIPTION OF THE EMBODIMENTS

One of the primary benefits of using EJB components to design enterprise applications is that EJB components can effectively be written once and used substantially anywhere. That is, EJB components can be used by multiple applications and can be maintained by separate parties. For example, in a telecommunications application, EJB components for maintaining subscriber information can be maintained on a different server than EJB components for providing rate information. The separate maintenance is significant because different parties may be responsible for different aspect of the service or business logic. The division handling rate schedules does not have to coordinate every change in pricing with the division handling customer care. This provides a significant advantage over traditional method oriented programming techniques where even small changes to isolated elements in the program could affect all elements of the programming code. Thus minor changes made to the software in response to redesign or updates could require rewriting of large portions of the program.

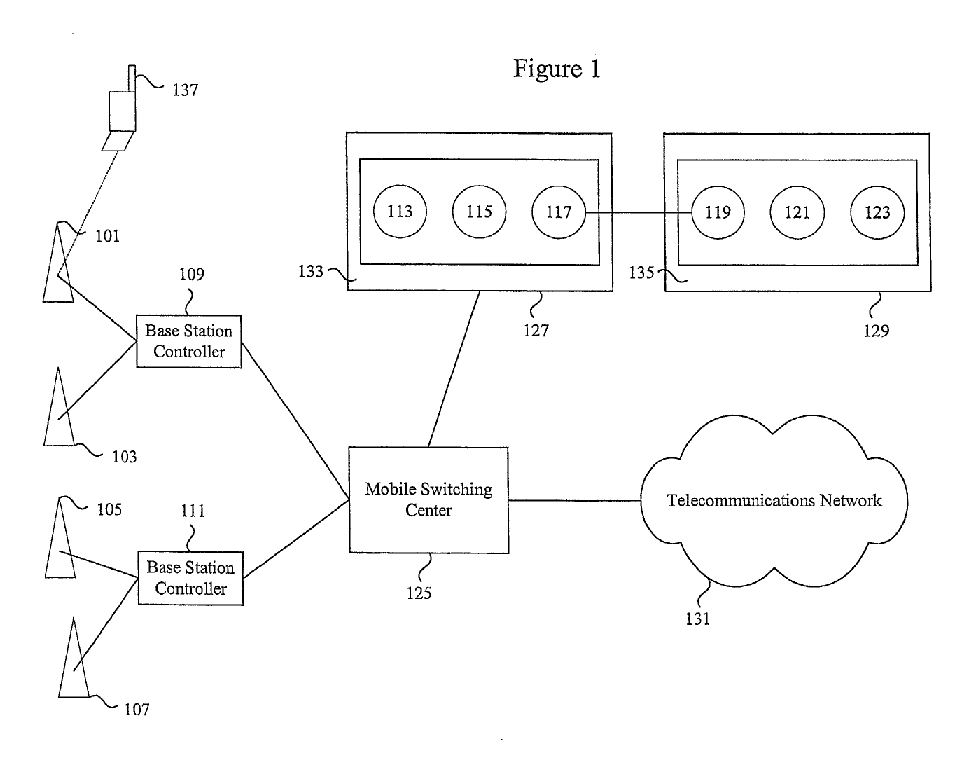

The distributed nature of EJB components, however, requires that EJB components be able to invoke other EJB components. In some applications, EJB components can invoke other EJB components synchronously. That is, a first EJB component can invoke a second EJB component and wait for control to return before proceeding with additional processing. In a number of applications, such waiting presents a problem, as for example, when a first EJB component is running on a system that is performing other processing. One such system is exemplified in the context of mobile telephony. FIG. 1 is a diagrammatic representation of a mobile telephony system that can use the techniques of the present invention. It should be noted that although the invention will be described in the context of mobile telephony, the techniques to the present invention are completely general and can be used in a variety of contexts unrelated to mobile telephony or even telephony. Some contexts in which the techniques of the present invention may be applied include chatting services, video, and IP telephony although again, the described techniques are completely general.

Antennas 101, 103, 105, 107 are connected to base station controllers 109 and 111. Antennas 101, 103, 105, 107, are in communication with various mobile handsets including handset 137. Many of these mobile handsets can be in use at the same time. Antenna 101, can be assigned certain frequency channels that are provided to active various mobile handsets. As would be appreciated by one of skill in the art, base station controllers 109 and 111 control functions that handle radio communications. Base station controllers 109 and 111 typically manage radio resources and network information and convey messages between the mobile handsets and the mobile switching center 125. Mobile switching center 125 can determine whether to pass particular messages onto a telecommunications network 131. For example, a mobile switching center 125 uses a J2EE server 127 to determine whether a call setup from the mobile handset 137 should be allowed. When the mobile handset 137 initiates a call, a registration message is transmitted to mobile switching center 125. Mobile switching center 125 conveys this information to J2EE server 127. J2EE server 127 comprises a container 133 and EJB components 113, 115, and 117. J2EE server 127 can be coupled with another J2EE server 129 comprising container 135 and components 119, 121, 123.

Components 113, 115, and 117 may be responsible for determining whether the mobile handset is provisioned on the mobile network. Depending on the protocol used, the mobile handset 137 may transmit at electronic ID number and/or a mobile ID number to the mobile switching center 125. J2EE server 127 uses components 113, 115, and 117 to determine whether the mobile ID number and/or electronic ID number are contained in a database of provisioned mobile users. If the ID numbers are not contained in the database, J2EE server instructs mobile switching center 125 to prevent call setup for the mobile handset. If the ID numbers are contained in the database, J2EE server 127 may need to determine other parameters before giving instructions to mobile switching center 125. For example, J2EE server 127 may need to determine how many minutes a mobile handset 137 has remaining before a call should be automatically disconnected. A mobile unit 137 can be allocated a certain number of minutes on a prepaid calling plan.

EJB components for determining how many minutes remain on a calling plan may be directly accessible to EJB component 117. However, EJB components for determining when to drop a call may not be directly accessible to EJB component 117. This may result from the fact that the EJB components for determining when to drop a call are maintained by separate J2EE server 129. Component 117 on J2EE server 127 invokes component 119 on J2EE server 129. However, component 119 may take some time to process the invocation. Meanwhile, mobile switching center 125 may receive new messages from a variety of mobile handsets that require processing by J2EE server 127. J2EE server 127 should not delay processing the additional messages because component 117 is waiting for response from component 119.

Synchronous invocations of component 119 typically require component 117 to either wait for a response from component 119, poll for a response, or invoke a component 119 using a separate thread. All of these techniques introduce computational overhead and delay into the processing of J2EE server 127. CORBA allows asynchronous invocation of remote objects. However, CORBA introduces derived types that increase the complexity of the programming model. The techniques to the present invention, however, allow component 117 to asynchronously invoke component 119 while avoiding the use of derived types and maintaining an elegant programming model. In one embodiment, the asynchronous proxies or stubs have the same type as the original interface. There is no need for type extension. The original type can be used for invocation purposes.

J2EE server 127 can continue to process messages from mobile switching center 125 while component 119 handles the invocation from component 117. Component 117 can invoke component 119 without having to wait for a reply, polling, or using a separate thread. J2EE server 127 can robustly handle incoming messages without delay arising from an invocation of a remote object. Asynchronous object invocations as described in the techniques of the present invention are not only useful in a variety of applications, but are also an explicit requirement of many telecommunications providers.

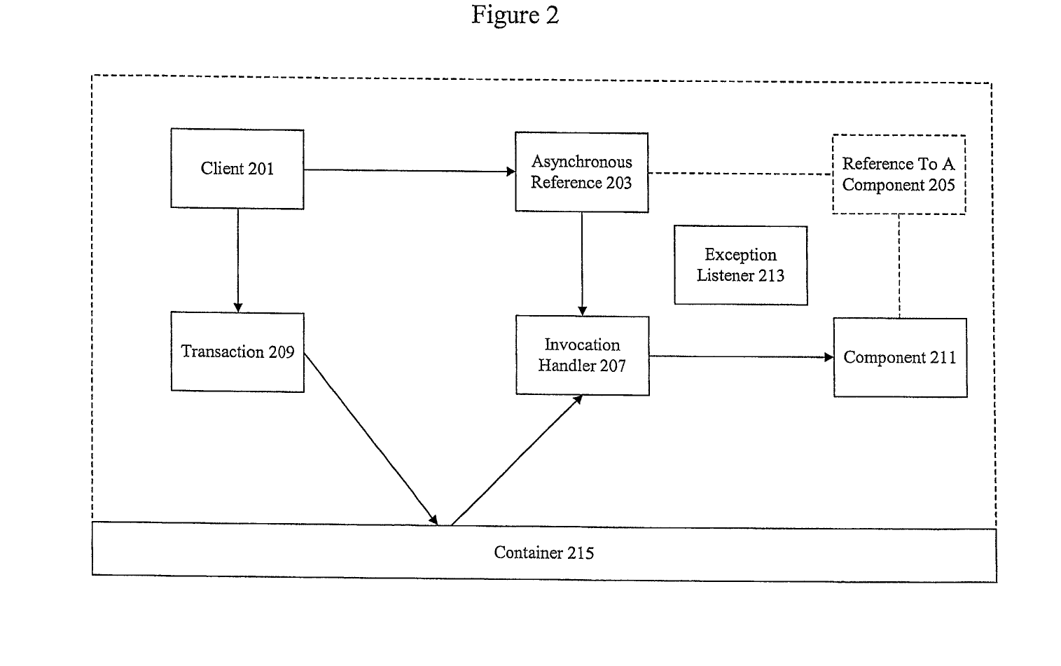

FIG. 2 is a diagrammatic representation describing asynchronous object invocations, according to specific embodiments. The techniques described in FIG. 2 may be used for a component 117 invoking a component 119 as shown in FIG. 1. A client 201 determines that a component required to handle a particular message or process can not be accessed directly. As noted above, this may be due to the fact that a component 211 resides on a different server or even on a different network. It should be noted that although client 201 is referred to herein as a client, it typically is also acting as a server. A client 201 is a client with reference to component 211, but can be a server with reference to an external network. Client 201 may be receiving many message from an external network that require processing.

As will be appreciated by one of skill in the art, a client 201 wishing to invoke a remote component 211, typically does not invoke component 211 directly. Client 201 invokes component 211 by using an asynchronous proxy 203. According to various embodiments, asynchronous proxy 203 may take the form of a stub. Generally, a stub is an entity that only declares itself and the parameters it accepts. Stubs are commonly used as an interface for remote invocations. Stubs allow an object's interface to be separated from the object implementation.

The present invention allows asynchronous invocation of remote objects by placing simple requirements on the programming model. The object invocations are constrained to have a void return type and no application specific exceptions. A client 201 invoking a component 211 through asynchronous proxy 203 uses an invocation that has a void return type and no application specific exceptions. Instead, a call to asynchronous proxy 203 can set an exception listener and a scope. Generally, components or logic for receiving exceptions and an associated scope and for handling exceptions are referred to herein as exception listeners. The exception listener can be an object running on a client 201, on the server running component 211, or on some other server. Typically, however, client 201 does not need to know the exceptions that may occur when component 211 is invoked and consequently that exception listener is more closely associated with component 211. Generally, an identifier tag for the invoked component is referred to herein as a scope. The scope can include information identifying the request. As will be appreciated by one of skill in the art, the scope can include other types of information in various forms associated with the object invocation.

The exception listener can be stateless. That is, one exception listener can handle many types of exceptions from a variety of different components. When a client 201 calls asynchronous proxy 203, an exception listener is registered for a component 211. Since client 201 does not expect a return from asynchronous proxy 203, client 201 can proceed with transaction processing 209. Immediately proceeding to transaction processing 209 can be particularly important since it may not be desirable for a client 201 may be a server receiving many messages from an external network.

After asynchronous proxy 203 receives a message from client 201, asynchronous proxy 203 can queue the message requesting an invocation of component 211 along with its scope in a buffer associated with invocation handler 207. It should be noted that although the description of various embodiments uses a queue, a queue is not required to implement the techniques of the present invention. Worker threads associated with invocation handler 207 identify the exception listener and recognize the scope. When a component 211 becomes available, worker threads dequeue the message and invoke component 211.

For example, client 201 may be an apparatus or logic that determines whether the ID numbers of a mobile unit are stored in a database and whether to setup a call. Client 201 may receive hundreds of messages from various mobile units who are communicating over a mobile network. The mobile network may provide data as well as audio services. A client 201 can be processing hundreds of messages from various mobile handsets, many making requests to initiate calls. According to various embodiments, call records are written into a database to maintain mobile handset usage logs.

A client 201 can asynchronously invoke a request to write a call record to a database for tracking or billing a mobile user. A client 201 transmits a message to asynchronous proxy 203 to invoke component 211. Asynchronous proxy 203 queues the write call record message. Client 201 also registers an exception listener 213 by providing the scope. The scope, in this example, is the particular user associated with the call record that is written into the database. According to various embodiments, the particular user corresponds to component 211. The worker threads associated with invocation handler 207 dequeue the disconnect message and invoke component 211. The worker threads associated with invocation handler 207 invoke component 211 synchronously. It should be noted that although the worker threads associated with the invocation handler 207 synchronously invoke component 211, the original invocation by client 201 remains asynchronous.

Component 211 may disconnect successfully with no remote exceptions. However, if an exception does occur, the worker thread associated with invocation handler 207 handles the exception and provides the exception along with the scope to exception listener 213. The exception may be a failure to write the call record associated with a particular user. The database may temporarily be unavailable during the attempt to write the call record, or the record itself may be invalid. The identity or scope of the particular user is provided along with the disconnect failure exception to the exception listener 213.

Depending upon the particular implementation, the exception listener 213 may do nothing. Alternatively, exception listener 213 may request another attempt to write the call record. The exception listener 213 may set a counter to track repeated attempts to write the call record. It should be noted that client 201 does not need to be involved in the exception handling process. According to various embodiments, the exception listener is another component. The exception listener 213 provides a convenient mechanism for handling a variety of exceptions for different components in a system.

According to various embodiments, asynchronous invocation of a component may include the use of commit signals. Worker threads associated with a particular request may wait for a commit signal from the client 201 before invoking a component 211. The invocation handler and associated worker threads do not dequeue a particular request until a commit signal has been received from client 201 through container 215. A client 201 handling call setup may wish to write a call record associated with a particular mobile handset only after call setup is complete. In other words, a client 201 may asynchronously invoke component 211 to write a call record but may want the call record written only after an actual call has been established.

A client 201 transmits a message to asynchronous proxy 203 to write a call record associated with the initiation of a particular call. Client 201 registers an exception listener 213 and provides the exception listener 213 with the scope of the component 211. Asynchronous proxy 203 places the write call record in a queue associated with invocation handler 207.

According to specific embodiments, worker threads do not invoke object 111 until transactional processing 209 has completed. Since the invocation of component 211 is asynchronous, client 201 can proceed with transactional activity 219. The transactional activity 219 may be the activity that actually initiates a call. After transactional activity 219 completes, that is, a call is actually initiated, a commit signal is transmitted to container 215 and the container 215 conveys the commit signal to invocation handler 207. The worker threads associated with invocation 207 can then invoke component 211 to write the call record.

According to various embodiments, container 215 is a J2EE container. As will be appreciated by one of skill in the art, a container manages methods such as instance pooling, multithreaded behavior, and transactional behavior of the various components. The container is part of the application server and monitors messages between components. For a J2EE container, the components are Enterprise JavaBeans.

As noted above, the container 215 conveys the commit signal to invocation handler 207. Although component 211 may have been available for invocation prior to the arrival of the commit signal, worker threads associated with invocation handler 207 will not invoke component 211 until the commit signal has arrived. It should be noted that transactional processing 209 may take an extended period of time. Component 211 may have become available long before transactional processing 209 has finished. For example, component 211 may have been available for an invocation of write call record before the call was actually initiated. However, worker threads associated with invocation handler 207 do not dequeue the write call record message until call setup is actually completed.

The commit signal processing allows an object invocation to occur as soon as transaction processing completes. Without the commit signal, an object invocation may occur significantly before or after transaction processing finishes.

According to various embodiments, invocation handler 207 may be associated with several queues. One queue may hold messages that require a commit signal before a worker thread uses the message to invoke a component. Another queue may hold messages that are used by a worker thread to invoke a component as soon as the component becomes available.

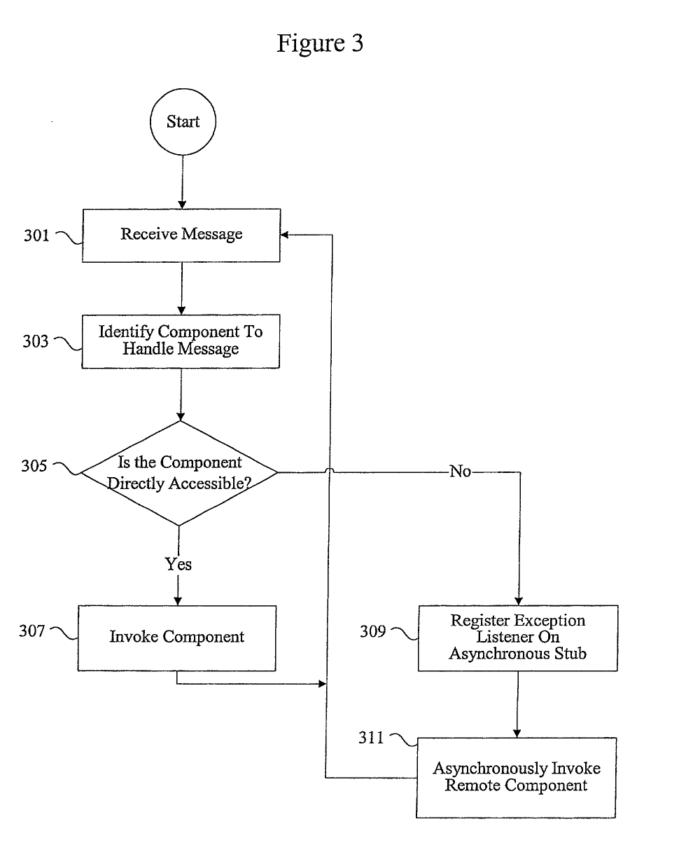

FIG. 3 is a process flow diagram showing a client 201 performing asynchronous component invocation. At 301 a client 201 receives a message. The message may arrive from a server from an external network. Although the particular embodiment described has a client 201 receiving a message, it should be noted that a client may have processing absent receipt of messages that can use invocation of a remote object. The client identifies a component to handle the message at 303. For example, a registration message from eight particular mobile unit is received at 301. At 303, the client determines the component associated with the particular mobile unit. As noted above, the component may or may not be directly accessible. If it is determined at 305 that the component is directly accessible, the component is invoked at 307. If, however, it is determined that a component is not directly accessible, asynchronous object invocation is performed. The component may not be directly accessible because it may be located on a remote server or it may be associated with a different process located on the same machine. At 309, an exception listener is registered on an asynchronous stub. A new exception listener may be registered for each component. Alternatively, a reusable exception listener may be stateless and handle a variety of exceptions and components. After the exception listener is registered on the asynchronous stub, the remote component is asynchronously invoked at 311. Asynchronous invocation means that the client 201 can continue processing or receiving messages while the invocation of the remote component occurs. The framework for asynchronous invocation specifies that the invocation has a void return type and there are no application-specific exceptions. Having the prior constraints allows asynchronous object invocations while maintaining an efficient programming model.

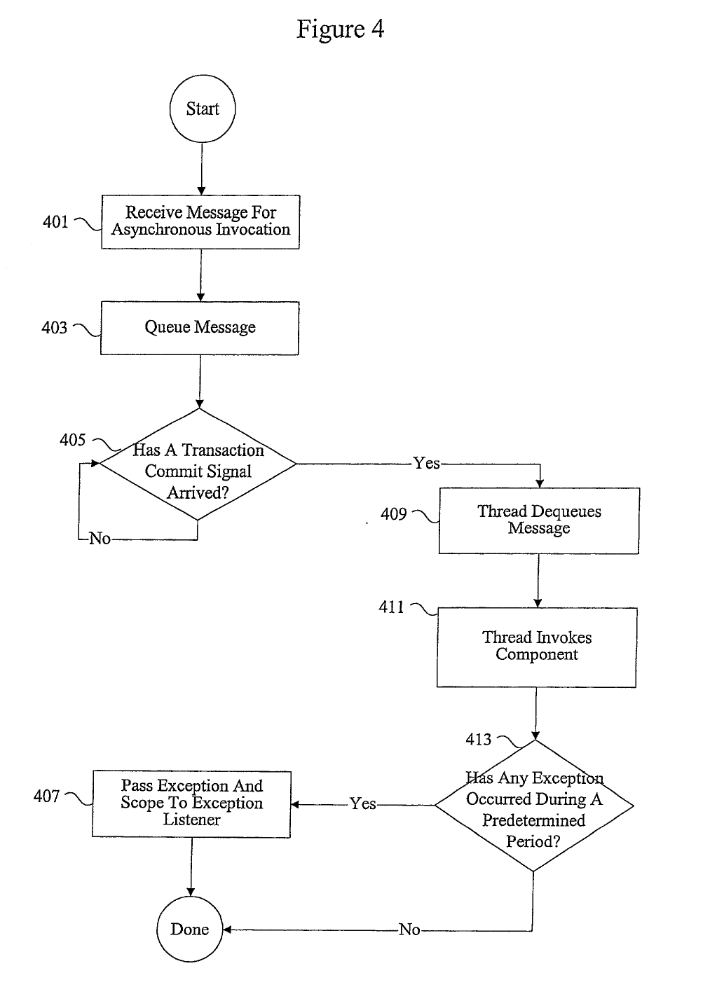

FIG. 4 is a process flow diagram describing asynchronous invocation of a remote component, according to specific embodiments. At 401 and asynchronous proxy 203 receives a message from client 201 invoking a component asynchronously. The message is queued at 403. The message can be queued in one of a plurality of buffers. Worker threads associated with one buffer may dequeue messages from one buffer immediately when a component becomes available. Worker threads associated with a different buffer may dequeue message from the buffer only when the component becomes available and a transaction commit signal has arrived. According to various embodiments where transaction commit signal are used, it is determined at 405 whether the transaction commit signal has arrived. As noted above, the transaction commit signal is typically received from a container that monitors message transmissions between objects are components. If a transaction commit signal has not arrived, the message is not is not dequeued. If a transaction commit signal has arrived, a thread or worker thread dequeues the message at 409.

It should be noted that using the transaction commit signal is not required to practice the techniques of the present invention. A message may be dequeued as soon as a component becomes available. At 411, the thread invokes the component. As will be appreciated by one of skill in the art, the thread identifies the exception listener associated with component. If it is determined that no exceptions have occurred during a predetermined period at 413, the exception listener is not required. The predetermined period of time may be set by measuring a range of times elapsed during component invocation. If an exception does occur during a predetermined period at 413, the thread passes the exception as a scope of the exception to the exception listener at 407.

The exception listener can then determine how to handle the particular exception using the scope. The exception listener may ignore the exception its entirety or may request that the component be invoked again. It should be noted that processes described in be above process flow diagram do not need to be practiced in specific sequence. For example, after a transaction commit signal has been received at 405, the message can be marked as ready for dequeueing. A thread can then dequeue the message when the component becomes available at 409. It should be noted, that the component may become available before or after the transaction commit signal has arrived at 405. It should also be noted that the processes in the flow diagrams can be performed using separate threads. For example a worker thread can be responsible for dequeueing a message and invoking an object. The worker thread can also determine whether any exceptions have occurred during object invocation. A separate thread can be responsible for receiving messages for asynchronous invocation and for queueing the messages. A different container thread, can wait for a transaction commit signal and prepare the message for removal from the queue by the worker thread.

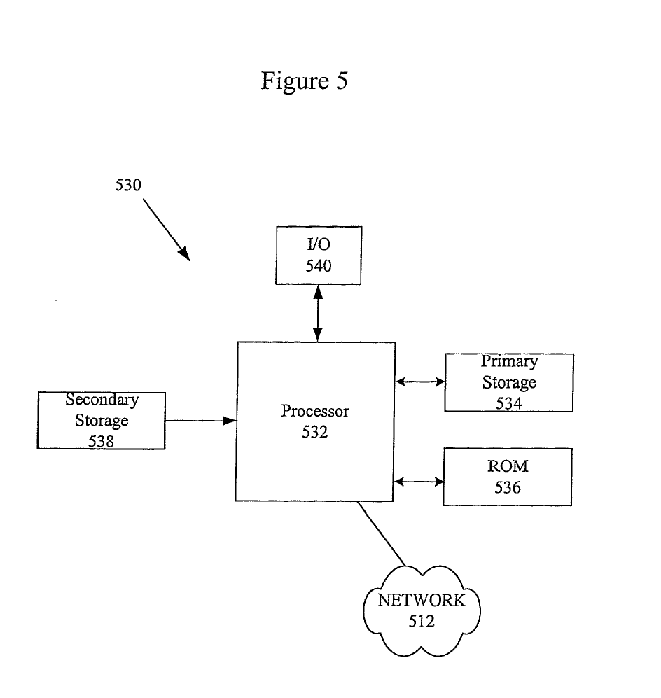

Clients and servers using asynchronous component invocation may generally be implemented on any suitable computing system. FIG. 5 illustrates a typical, general-purpose computer system suitable for implementing the present invention. The computer system 530 includes at least one processor 532 (also referred to as a central processing unit, or CPU) that is coupled to memory devices including primary storage devices 536 (typically a read only memory, or ROM) and primary storage devices 534 (typically a random access memory, or RAM).

As is well known in the art, ROM acts to transfer data and instructions uni-directionally to the CPUs 532, while RAM is used typically to transfer data and instructions in a bi-directional manner. CPUs 532 may generally include any number of processors. The CPUs 532 are involved in determining what component should be invoked to handle particular messages. CPUs 532 can also perform transaction processing and exception handling. Both primary storage devices 534, 536 may include any suitable computer-readable media. A secondary storage medium 538, which is typically a mass memory device, is also coupled bi-directionally to CPUs 532 and provides additional data storage capacity.

The mass memory device 538 is a computer-readable medium that maybe used to store programs including computer code, data, and the like. Typically, mass memory device 538 is a storage medium such as a hard disk, a tape, an optical disk, a floppy disk, or a computer disk read only memory (CD-ROM) which is generally slower than primary storage devices 534, 536. Mass memory storage device 538 may take the form of a magnetic or paper tape reader or some other well-known device. It will be appreciated that the information retained within the mass memory device 538, may, in appropriate cases, be incorporated in standard fashion as part of RAM 536 as virtual memory. A specific primary storage device 534 such as a CD-ROM may also pass data uni-directionally to the CPUs 532. Components may be loaded from secondary storage to primary storage during component invocation.

CPUs 532 are also coupled to one or more input/output devices 540 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 532 optionally may be coupled to a computer or telecommunications network, e.g., an internet network or an intranet network, using a network connection as shown generally at 512. With such a network connection, it is contemplated that the CPUs 532 might receive information from the network, or might output information to the network in the course of performing the above-described method steps. Such information, which is often represented as a sequence of instructions to be executed using CPUs 532, may be received from and outputted to the network, for example, in the form of a computer data signal embodied in a carrier wave. According to various embodiments, remote object invocation may be performed over a network. The above-described devices and materials will be familiar to those of skill in the computer hardware and software arts.

Although only a few embodiments of the present invention have been described, it should be understood that the present invention may be embodied in many other specific forms without departing from the spirit or the scope of the present invention. By way of example, although the steps associated with the various processes and methods of the present invention may be widely varied. In general, the steps associated with the methods may be altered, reordered, replaced, removed, and added. For instance, the invocation handler, component invocation and exception listener activities may be performed by different threads.

While the invention has been particularly shown and described with reference to specific embodiments thereof, it will be understood by those skilled in the art that changes in the form and details of the disclosed embodiments may be made without departing from the spirit or scope of the invention. For example, the embodiments described above may be implemented using firmware, software, or hardware. Moreover, embodiments of the present invention may be employed with a variety of communication protocols and should not be restricted to the ones mentioned above. The character code mapping system has variety of embodiments. Therefore, the scope of the invention should be determined with reference to the appended claims.

What is claimed is:

1. A computer-implemented method for a first component to invoke a second component asynchronously in an object-oriented computing environment, the computer-implemented method comprising:
receiving a request from a first component to invoke a second component;
maintaining the scope of the received request;
providing a thread for identifying the received request and invoking the second component, wherein the thread identifies an exception listener for handling exceptions associated with the invocation of the second component.

2. The computer-implemented method of claim 1, wherein the request has a return type of void.

3. The computer-implemented method of claim 1, wherein the request is associated with no application specific exceptions.

4 The computer-implemented method of claim 1, wherein the first and second components are associated with separate servers.

5. The computer-implemented method of claim 1, wherein the first and second components are Enterprise Java Bean components.

6. The computer-implemented method of claim 5, wherein the first and second components are associated with a container.

7. The computer-implemented method of claim 6, further comprising placing the request from the first component is placed in a queue.

8. The computer-implemented method of claim 7, wherein the worker thread dequeues the received request after receiving a transaction commit signal from the container.

9. The computer-implemented method of claim 8, wherein the exception listener receives the exception and the scope of the exception.

10. A computer-implemented method for a first component to invoke a second component asynchronously in an object-oriented environment, the computer-implemented method comprising:
identifying a second component for handling a message;
transmitting a request associated with the message from a first component to invoke the second component;
registering an exception listener on an asynchronous proxy associated with the second component.

11. The computer-implemented method of claim 10, wherein the asynchronous proxy has the same type as the second component.

12. The computer-implemented method of claim 10, wherein the request is associated with no application specific exceptions.

13. The computer-implemented method of claim 10, wherein the first and second components are associated with separate servers.

14. The computer-implemented method of claim 10, wherein the first and second components are Enterprise Java Bean components.

15. The computer-implemented method of claim 14, wherein the first and second components are associated with a container.

16. The computer program product comprising computer code for a first component to invoke a second component asynchronously, the computer readable medium comprising:
computer code for receiving a request from a first component to invoke a second component;
computer code for maintaining the scope of the received request;
computer code for providing a thread for identifying the received request and invoking the second component, wherein the thread identifies an exception listener for handling exceptions associated with the invocation of the second component;
a computer-readable medium for storing the computer codes.

17. The computer program product of claim 16, wherein the request has a return type of void.

18. The computer program product of claim 16, wherein the request is associated with no application specific exceptions.

19. The computer program product of claim 16, wherein the first and second components are associated with separate servers.

20. The computer program product of claim 16, wherein the first and second components are Enterprise Java Bean components.

21. The computer program product of claim 20, wherein the first and second components are associated with a container.

22. The computer program product of claim 21, further comprising placing the request from the first component is placed in a queue.

23. The computer program product of claim 22, wherein the worker thread dequeues the received request after receiving a transaction commit signal from the container.

24. The computer program product of claim 23, wherein the exception listener receives the exception and the scope of the exception.

25. A computer program product for a first component to invoke a second component asynchronously in an object-oriented environment, the computer program product comprising:
computer code for identifying a second component for handling a message;
computer code for transmitting a request associated with the message from a first component to invoke the second component;
computer code for registering an exception listener on an asynchronous proxy associated with the second component;
a computer-readable medium for storing the computer codes.

26. The computer program product of claim 25, wherein the asycnhronous proxy has the same type as the second component.

27. The computer program product of claim 25, wherein the request is associated with no application specific exceptions.

28. The computer program product of claim 25, wherein the first and second components are associated with separate servers.

29. The computer program product of claim 25, wherein the first and second components are Enterprise Java Bean components.

30. The computer program product of claim 29, wherein the first and second components are associated with a container.

31. An enterprise environment associated with a computing system, the enterprise environment comprising:
an asynchronous proxy for receiving a request from a first component to invoke a second component;
an exception listener coupled to the asynchronous proxy, wherein the exception listener uses a scope corresponding to the request to handle exceptions associated with the invocation.

32. The computer program product of claim 31, wherein the request has a return type of void.

33. The computer program product of claim 31, wherein the request is associated with no application specific exceptions.

34 The computer program product of claim 31, wherein the first and second components are associated with separate servers.

35. The computer program product of claim 31, wherein the first and second components are Enterprise Java Bean components.

36. The computer program product of claim 35, wherein the first and second components are associated with a container.

37. The computer program product of claim 31, wherein the worker thread invokes the second components after receiving a transaction commit signal from the container.

38. An enterprise environment associated with a computing system, the enterprise environment comprising:
memory containing a first component;
a processor coupled with memory, the processor configured to identify a second component for handling a message from the first component;
an interface coupled with the processor and memory, the interface configured to transmit a request associated with the message from the first component to invoke the second component, wherein the interface also transmits information to register an exception listener on an asynchronous proxy associated with the second component.

39. The computer-implemented method of claim 38, wherein the request has a return type of void.

40. The computer-implemented method of claim 38, wherein the request is associated with no application specific exceptions.

41. The computer-implemented method of claim 38, wherein the first and second components are associated with separate servers.

42. The computer-implemented method of claim 38, wherein the first and second components are Enterprise Java Bean components.

43. An apparatus for a first component to invoke a second component asynchronously in an object-oriented computing environment, the apparatus comprising:
means for receiving a request from a first component to invoke a second component;
means for maintaining the scope of the received request;
means for providing a thread for identifying the received request and invoking the second component, wherein the thread identifies an exception listener for handling exceptions associated with the invocation of the second component.

44. An apparatus for a first component to invoke a second component asynchronously in an object-oriented environment, the computer-implemented method comprising:
means for identifying a second component for handling a message;
means for transmitting a request associated with the message from a first component to invoke the second component;
means for registering an exception listener on an asynchronous proxy associated with the second component.
